(19) United States
(12) Patent Application Publication
(10) Pub. No.: US 2022/0012968 A1
(43) Pub. Date: Jan. 13, 2022

(54) DOOR ACCESS CONTROL SYSTEM BASED ON USER INTENT

(71) Applicant: Tascent, Inc., Los Gatos, CA (US)

(72) Inventors: Keith W. Hartman, Redwood City, CA (US); Dan Potter, San Jose, CA (US); Sunny Wang, Saratoga, CA (US); Wojtek Mandrysz, Rydultowy (PL)

(21) Appl. No.: 17/368,778

(22) Filed: Jul. 6, 2021

Related U.S. Application Data
(60) Provisional application No. 63/050,623, filed on Jul. 10, 2020.

(51) Int. Cl. G07C 9/37

(52) U.S. Cl. CPC G07C 9/37; G06K 9/00288

(57) ABSTRACT

An access control system is described for unlocking a door as an individual approaches the door based on the individual's intention to open the door, biometric match with authenticated stored information, and whether the presented biometric information from the individual is real. Related methods are also described.

### CROSS-REFERENCE TO RELATED APPLICATIONS

This application claims priority to provisional application No. 63/050,623, filed Jul. 10, 2020, and entitled “DOOR ACCESS CONTROL SYSTEM BASED ON USER INTENT”, incorporated herein by reference in its entirety.

### BACKGROUND OF THE INVENTION

### 1. Field of the Invention

This invention relates to door access control systems, and particularly, to door access control systems for permitting access based on recognizing a user's intent.

### 2. Description of the Related Art

Conventional biometrically enabled door access products require active participation from the user. The user needs to either place themselves in a certain location in front of the access point, or would need to position a fingertip or hand in a certain region for identification.

However, these systems have a number of drawbacks. The active participation of the user results in an extra time to open an access point. Also users need to alter their more habituated motion for opening doors to accommodate the biometric capture. If the user does not present according to the door specification, the door may not unlock. Also, existing systems can be subject to presentation attacks. The existing systems cannot detect if the presented subject is a real person rather than, for example, a digital display, a printout, or a 3-D mask.

Notwithstanding the above, an improved door access system is desired that can automatically permit entry of an authorized person through the door without the need of a key. An improved door access system is desired that combines the benefits of biometric access, while minimizing the additional participation requirements on the users. Additionally, an improved door access system that can recognize presentation attacks and imposters is desired.

### SUMMARY OF THE INVENTION

An access control system comprises at least one door; an electro-mechanical device for permitting access through the at least one door; one or more illumination sources; at least one camera in the vicinity of the door; and a computer processor framework attached to the door or, optionally, embedded in the door.

In embodiments, the processor framework is operable to perform several operations including but not limited to: compute a body motion of a subject within the scene based on a sequence of images; determine a level of intent the subject presents to the device based on the body motion of the subject; and activate the device based on the level of intent.

In embodiments, the processors are further operable to determine a level of confidence the subject is a match with an authorized individual based on evaluating biometric information, optionally the face, of the subject and the authorized individual; and to activate the device based on the level of intent and the level of confidence.

In embodiments, the processor is further operable to compute a level of authenticity the subject is a real person, and to activate the device based on the level of intent, the level of confidence, and the level of authenticity.

In embodiments, a system uses multi-wavelength indirect time of flight depth and imaging sensors to obtain accurate measurement of directional and wavelength dependent optical properties of 3-D surfaces. The information measured by the disclosed systems allows for high confidence detection of presentation attacks for the biometric systems.

In embodiments, a non-transitory program storage device, readable by a processor and comprising instructions stored thereon, is operable to cause one or more processors to: acquire a sequence of images of a scene in a vicinity of an access control device; store the sequence of images in a memory; compute a body motion of a subject within the scene based on the sequence of images;

determine a level of intent the subject presents to the access control device based on the body motion of the subject; determine a level of confidence the subject is a match with an authorized individual based on evaluating biometric information of the subject and the authorized individual; and activate the access control device based on the level of intent and the level of confidence.

In embodiments, the instructions stored thereon further cause the one or more processors to: determine the level of confidence following determining the level of intent.

In embodiments, the instructions stored thereon further cause the one or more processors to: determine the proximity of at least a portion of the subject to the access control device, and said level of intent being further based on proximity to the access control device.

In embodiments, the instructions stored thereon further cause the one or more processors to: extract orientation motion of a face of the subject, and said level of intent being further based on said orientation motion of a face.

In embodiments, the instructions stored thereon further cause the one or more processors to: extract orientation motion of a torso of the subject, and said level of intent being further based on said orientation motion of a torso.

In embodiments, the instructions stored thereon further cause the one or more processors to: compute a level of authenticity of the subject, and prohibit activating the access control device based on the computed level of authenticity.

In embodiments, the instructions stored thereon further cause the one or more processors to: compute the level of authenticity based on emitting multiple wavelengths of light towards the face of the subject, and detecting reflectance/absorption of the multiple wavelengths.

In embodiments, the instructions stored thereon further cause the one or more processors to: identify a human body from the sequence of images; generate a body feature vector for the human torso based on the sequence of images; compute body pose orientation, face pose orientation, and face size based on the body feature vector; and using an intention classifier trained to accept the body feature vector, body pose orientation, face pose orientation, and face size, determine the level of intent based on output from the intention classifier for the subject.

In embodiments, the instructions stored thereon further cause the one or more processors to: generate a body feature vector based on the sequence of images; produce a face crop from the sequence of images; using a face recognition classifier trained to accept the body feature vector and the face crop, determine a set of face embeddings for the subject; compare the set of face embeddings for the subject to that of the authorized individual; and determine the level of confidence based on the comparing step.

In embodiments, the instructions stored thereon further cause the one or more processors to: activate the access control device by unlocking a lock of a door.

In embodiments, the instructions stored thereon further cause the one or more processors to: determine the level of confidence based on biometric information arising from a face of the subject.

Methods for permitting access based on the user's intent, face matching, and authenticity are also described.

The description, objects and advantages of embodiments of the present invention will become apparent from the detailed description to follow, together with the accompanying drawings.

### BRIEF DESCRIPTION OF THE DRAWINGS

FIG. 1 is an illustration of an access control system for unlocking a door;

FIG. 2 is a flow chart of a door access control process in accordance with an embodiment of the invention;

FIG. 3 is a block diagram of an access control system in accordance with an embodiment of the invention;

FIG. 4 is a flow chart illustrating an overview of an intention detection process in accordance with an embodiment of the invention;

FIG. 5 is a flow chart illustrating an intention detection process in accordance with another embodiment of the invention;

FIG. 6 is a flow chart illustrating a confidence level detection process that the individual's face matches an authenticated face in accordance with an embodiment of the invention;

FIG. 7 is a flow chart illustrating a presentation attack detection (PAD) process for determining whether the presented biometric information from the individual is real in accordance with an embodiment of the invention;

FIG. 8 is an illustration of a PAD process for determining whether the presented biometric information from the individual is real in accordance with an another embodiment of the invention;

FIG. 9 is a chart illustrating skin light reflectance versus wavelength; and

FIG. 10 is an illustration of an electro-mechanical door access control device in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein is an access control system and related methods.

Access Control Overview

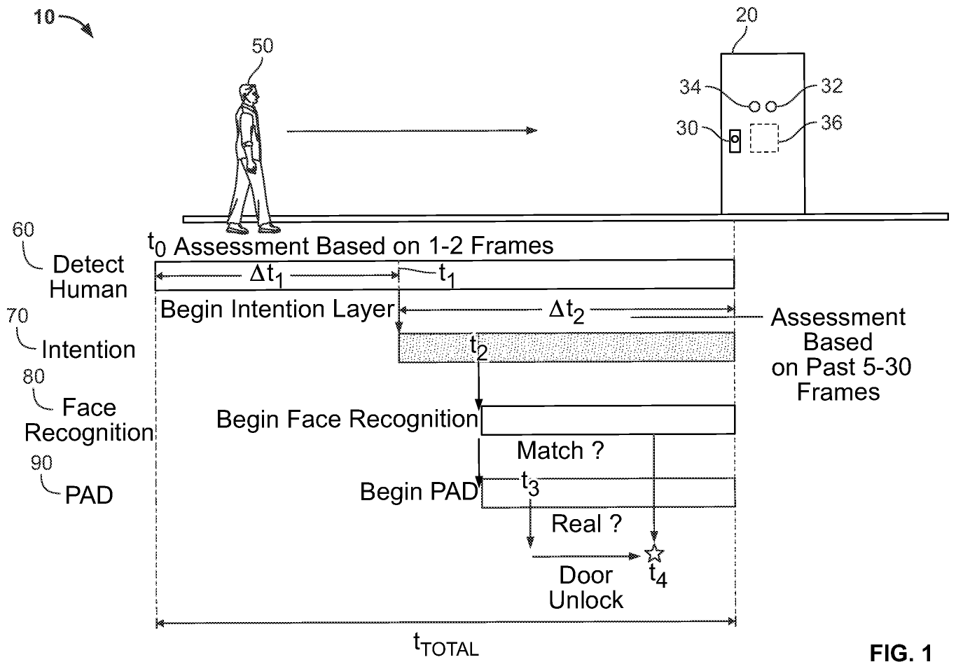

FIG. 1 is an illustration of an access control system 10 for unlocking a door 20 as the individual 50 approaches the door. The access control system 10 is shown having an electromechanical locking device 30, a camera 32, an illumination device 34, and an onboard or local processor 36. The components are preferably secured on or within the door 20. Padding and shock absorbing materials can be arranged with the components to mitigate any wear and excessive forces arising from repeated door action.

The door access control system shown in FIG. 1 operates according to four phases or stages including detection 60, intention 70, face recognition 80, and presentation attack detection 90.

Initially, the system scans the environment for the presence of a human. If a human is sensed, a time counter commences. The human detection assessment 60, as described further herein, is carried out quickly (e.g., based on as few as 1-2 image frames) and in embodiments is performed in less than a second.

The intention detection phase 70 commences at t₁, after confirming human detection. As described further herein, the intention phase 70 computes a rating or score whether the individual is going to reach for the handle to open the door based on a number of factors including body motion. This phase may be performed quickly (e.g., based on 5-30 frames) and in embodiments is performed in less than 2 seconds.

The face recognition phase 80 commences at t₂. As described further herein, the face recognition phase 80 computes a rating or score whether the individual's presented biometric information (namely, face embeddings) match with authenticated stored information. This phase may also be performed quickly (e.g., based on 5-30 frames) and in embodiments is performed in less than a second.

The presentation attack detection (PAD) phase 90 commences at t₃. As described further herein, the PAD phase 90 computes a rating or score whether the presented biometric information from the individual is real. This phase may also be performed quickly (e.g., based on 5-30 frames) and in embodiments is performed in 0.5 to 5 seconds.

In preferred embodiments, the total time (tₜₒₜₐₗ) for performing the above described phases can range from 0.5 to 5 seconds, and more preferably 1 to 2 seconds, at which point the computer controller instructs the door to unlock if criteria for each of the assessments is met or within an acceptable range. Additionally, it is to be understood that although the intention 70, face recognition 80, and presentation attack detection 90 phases are shown commencing in sequence at t₂, and t₃, the invention is not so limited. The different phases may be performed in parallel or in any logical order where such steps are not exclusive of one another.

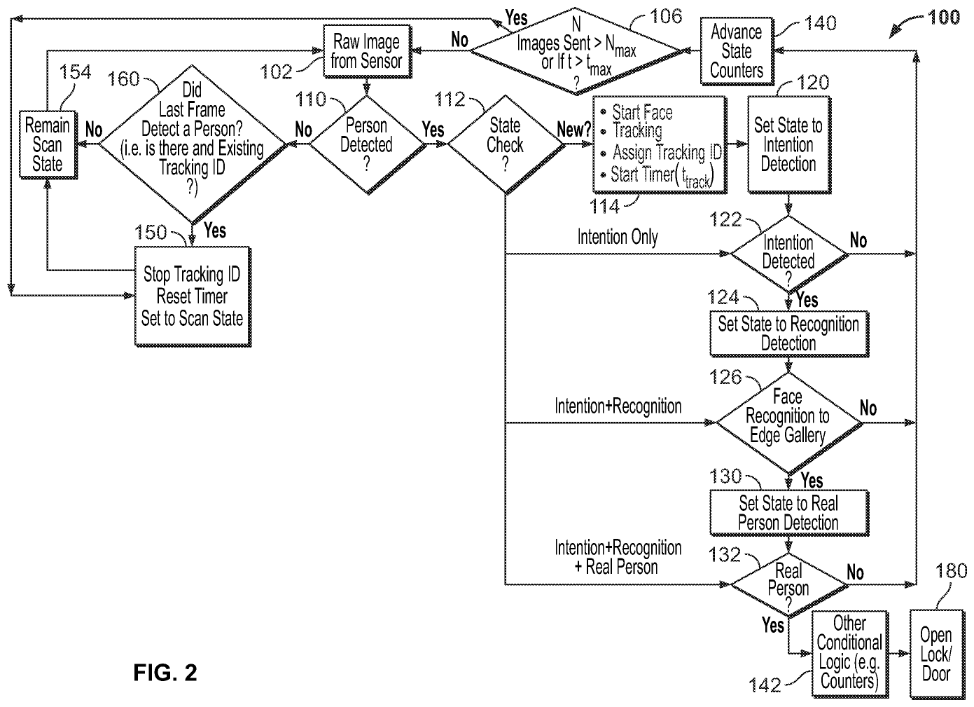

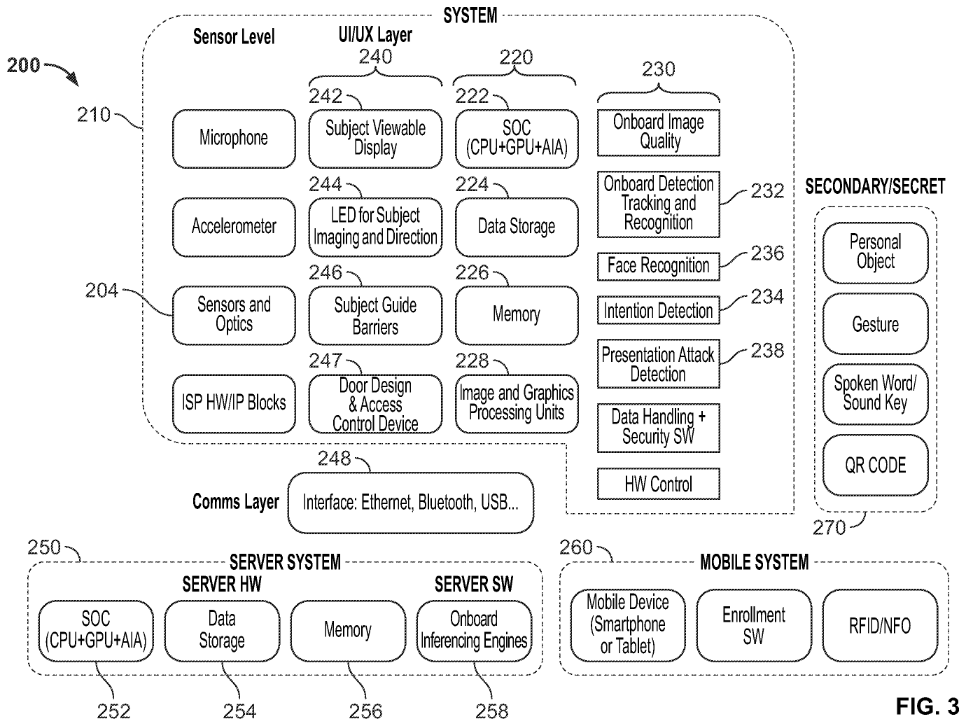

With reference to FIG. 2, an access control process 100 is illustrated for opening or unlocking a door such as the door 20 shown in FIG. 1. To facilitate understanding of the process 100, and the performance of exemplary steps of the process, reference is also made to the components and functionality shown in the system block diagram 200 shown in FIG. 3.

Step 102 states to obtain raw images from a sensor. In a preferred embodiment, one or more cameras and sensors 204 are positioned in the operative area to obtain unobstructed images. Examples of cameras, include without limitation, Leopard Imaging CMOS camera, model number LI-USB30-AR023ZWDRB (Freemont, Calif.). The computer (or on-board image signal processor) may also control or automate exposure settings to optimize the amount of light exposed to the camera sensor. Examples of sensors include, without limitation, the IMX501 image sensor manufactured by Sony Corporation (Tokyo, Japan). The sensors and cameras may comprise their own image processing software. The cameras are preferably positioned downstream of the individuals, facing the individuals, above the door, and in some embodiments, attached to the door or moving access structure itself.

With reference again to FIG. 2, step 110 states to detect person, and optionally other objects within the images. This step can be carried out by computer hardware 220 executing one or more software modules or engines 230. Examples of hardware includes processors 222 (e.g., CPU, GPU, or AIA), data storage 224, memory 226, and various image and graphics processing units 228.

A detection tracking and recognition engine or module 232 searches for faces and optionally other objects as the candidate walks towards the access control device or door. A wide range of face and object detection and tracking algorithms may be employed on the system 210 by the processor 220. Non-limiting examples of suitable face and object detection and tracking algorithms include: King, D. E. (2009). “Dlib-ml: A Machine Learning Toolkit” (PDF). J. Mach. Learn. Res. 10 (July): 1755-1758. CiteSeerX 10.1.1.156.3584 (the “dlib face detector”); and the JunshengFu/tracking-with-Extended-Kalman-Filter. The dlib face detector is stated to employ a Histogram of Oriented Gradients (HOG) feature combined with a linear classifier, an image pyramid, and sliding window detection scheme.

Additionally, a user interface or human factor layer 240 is shown in the system 210 of FIG. 3. In embodiments, a subject viewable display 242 assists in directing the person to the door, as well as to look towards the camera. Optionally, LED 244 such as a LED light ring surrounding the display is indicative of direction or visually changes based on position of the subject. As described further herein, other human factors can be included in the system including guide rails 246 and virtual or augmented reality type graphics to assist in guiding the candidate to look in the direction of the cameras, and ultimately to the door access device 247.

No Person Detected

In the event a face or human is not detected at step 110 (e.g., candidate falls or otherwise drops out of the FOV) or the image fails to pass a minimum quality threshold, the method proceeds to step 160. The state is set to ‘idle’.

Step 160 states to determine whether a tracking ID exists for the candidate. If a tracking ID does not exist (e.g., the candidate is new), the process simply proceeds to step 154. The state of the system remains at ‘scan’, and the live stream of images (step 102) is interrogated for a person.

If, at step 160, a tracking ID exists for the candidate (e.g., the candidate was being tracked but has fallen or leaned over to pick up a belonging), then the method proceeds to step 150. In embodiments, step 150 stops the current tracking ID, and resets the timer. Following resetting the tracking ID and timer, the state is set to ‘scan’ and the live stream of images (step 102) is interrogated for a human or face having a minimum level of quality.

Person Detected

In the event a human is detected and passes the minimum quality threshold at step 110, the system assesses the instant state of the system (step 112) for determining the current state and which phase to perform, namely, intention detect 122, face recognition 124 or presentation attack detection 130.

In the event the state is set at ‘person detected’, the method proceeds to step 114 to commence face and/or body tracking, assign tracking ID, and to commence the timer.

The method then proceeds to step 120 and assigns the system state to intention detection.

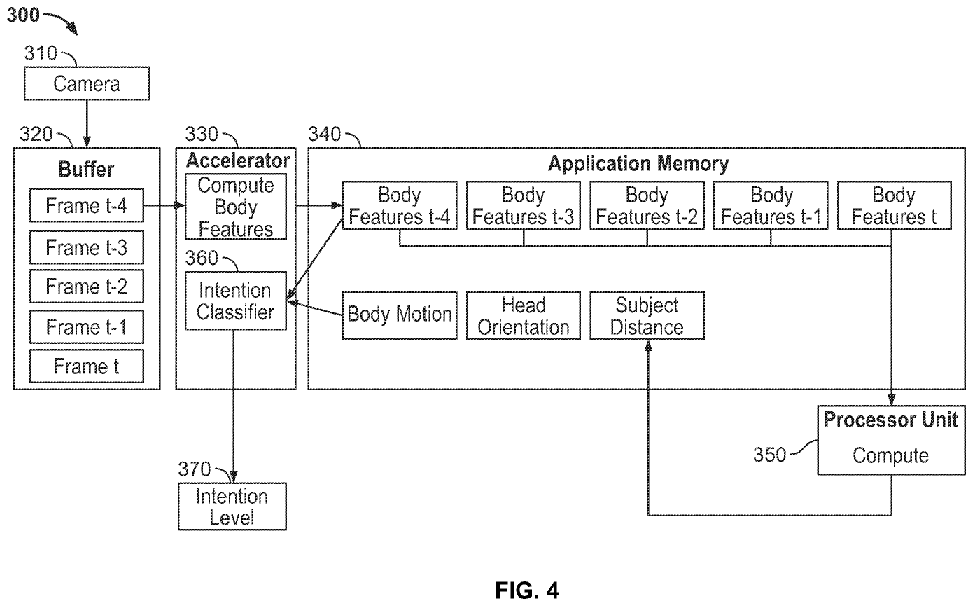

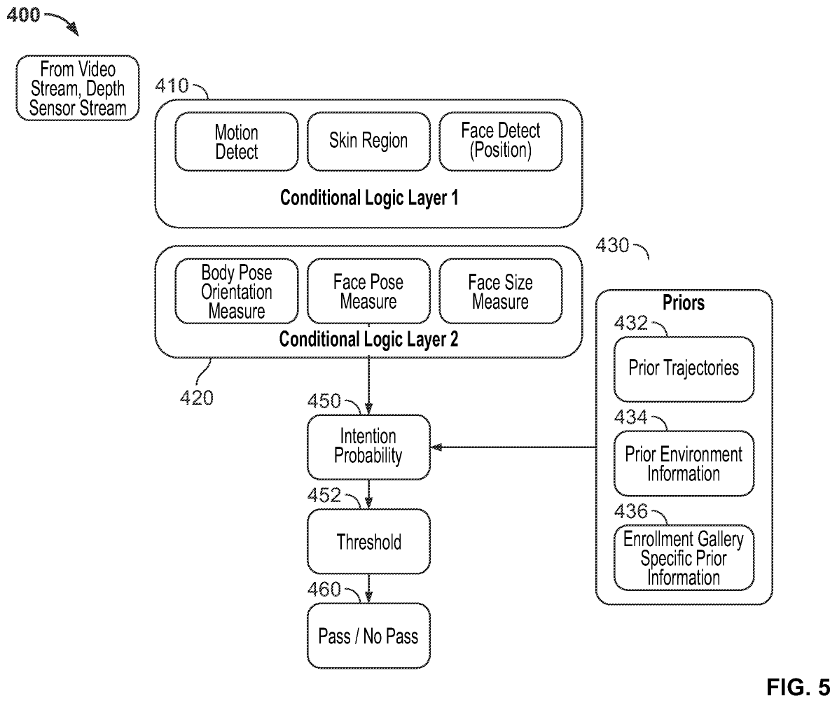

Step 122 is intention detection. As described herein, in connection with FIGS. 4-5, step 122 determines a level of intent the subject presents to unlock the door lock based on the body motion of the subject. This step may be performed by an intention detection module 234 on the system 210, as described further herein. If the level of intent is deemed insufficient, the method returns to step 140 and the state counters for number of images and time is updated.

Example counter states, as discussed herein, include the number of frames idle, number of frames same person detected, number of frames intention detection, and number of frames face recognition.

Output from the state counter 140 is interrogated at step 106 for whether the process should be (a) restarted for a new candidate, or (b) continued for the same candidate. As described further herein, thresholds for determining whether to continue or restart can be based on time elapsed, the number of images submitted, candidate is outside the field of view, etc. In preferred embodiments, the process is restarted if the total time elapsed is greater or equal to 10 seconds, more preferably 5 seconds, and in embodiments, 3 seconds. In another preferred embodiment, the process is restarted if 30 frames have been submitted.

If it is determined to restart the process for a new candidate, step 150 stops the current tracking ID, resets the timer, and sets the state to ‘scan’. After the tracking ID and timer have been reset, the process proceeds to step 154 for scanning, and the face tracking is commenced according to the steps described above.

In contrast, if the level of intent is deemed adequate at step 122, the method proceeds to step 124 to update the system state to face recognition detection.

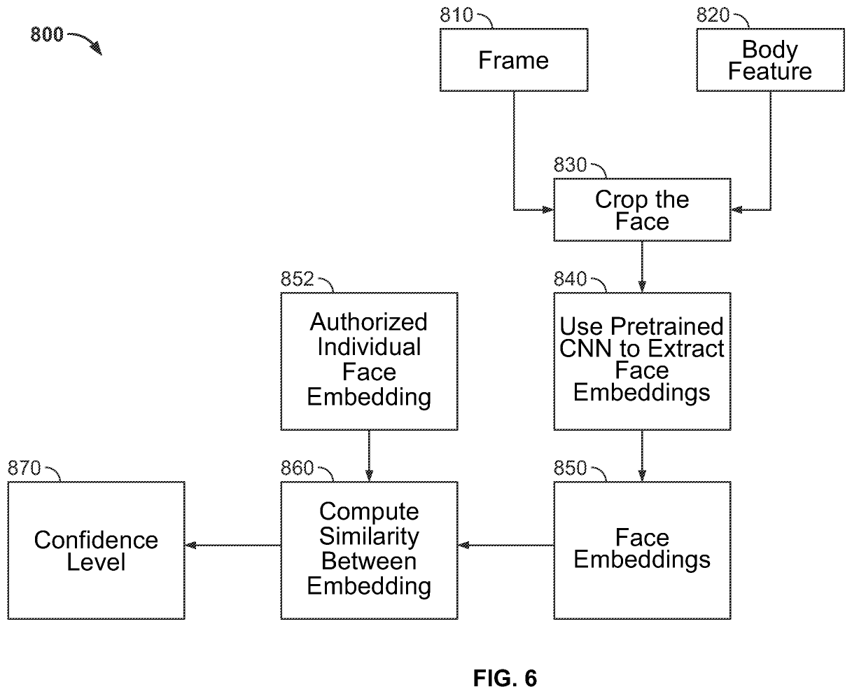

Step 126 states face recognition. As described further herein with reference to FIG. 6, this step determines a level of confidence the subject is a match with an authorized individual based on evaluating biometric information (e.g., the face) of the subject and the authorized individual. This step may be performed by an face recognition module 236 on the system 210. Exemplary algorithms for image matching include, for example, the Algorithms evaluated by the National Institute of Standards and Technology (NIST) Face Recognition Vendor Test (FRVT) and headquartered in Gaithersburg, Md. See, e.g., NIST Internal Report 8280 Natl. Inst. Stand. Technol. Interag. Intern. Rep. 8280, 81 pages (December 2019). If the level of confidence is deemed insufficient, the method returns to step 140. The state counters for number of images and time is updated accordingly, and the method proceeds as described above.

If the level of confidence is deemed adequate at step 126, the method proceeds to step 130 to update the state to real person detection, namely, presentation attack detection (PAD).

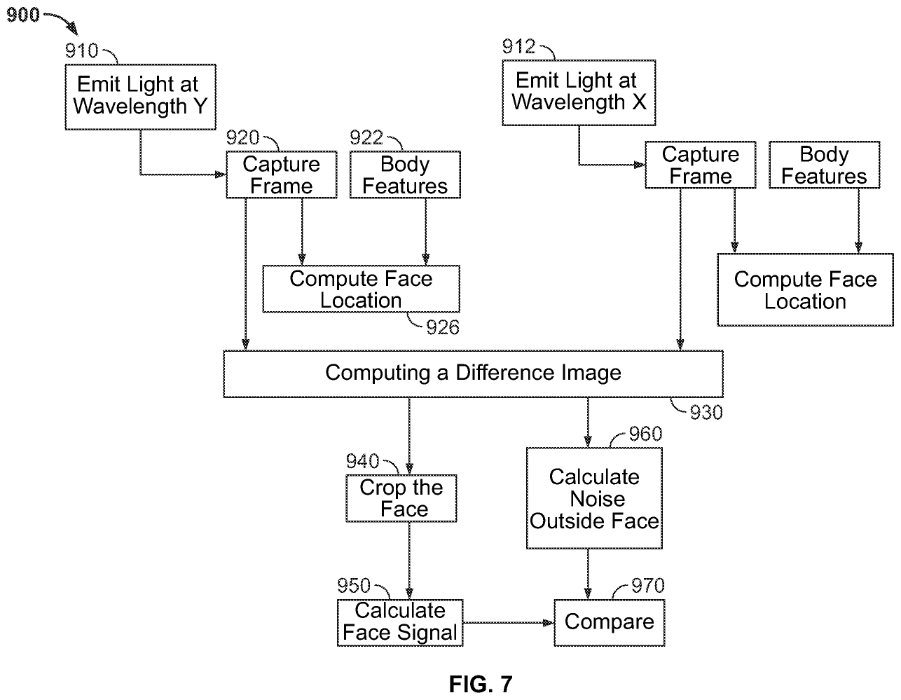

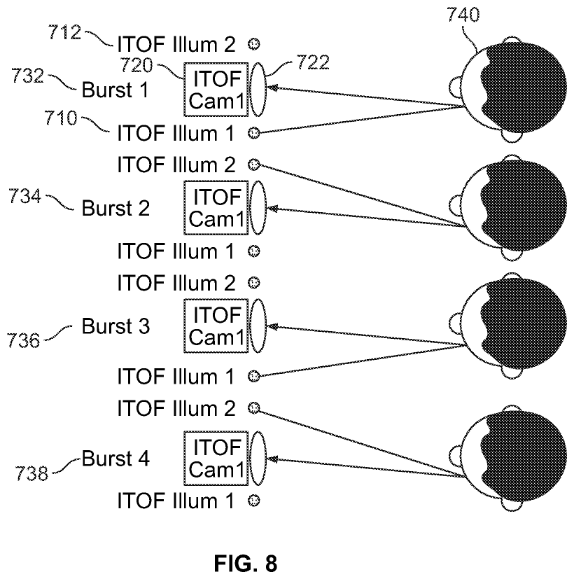

Step 130 states real person detection. This step computes a level of authenticity of the subject. As described further herein in connection with FIGS. 7 and 8, this step determines a level of authenticity that the person is a real person. It is based on emitting multiple wavelengths of light towards the face of the subject, and detecting reflectance/absorption of the multiple wavelengths. This step may be performed by a presentation attack detect engine 238 using data from the sensors and optics 204 on the system 210.

If the level of authenticity is deemed insufficient, the method returns to step 140. The state counters for number of images and time is updated accordingly, and the method proceeds as described above.

If the level of authenticity is deemed adequate at step 132, the method proceeds to step 180 to open/unlock. This step activates the access control device 247 based on, collectively, the level of intent, the level of confidence, and the presentation attack screening.

Optionally, and with reference to step 142, other conditional logic may be applied to determine whether to open/unlock the access control device 247 such as but not limited the use of time elapsed, number of frame images, etc.

Intention Detection

FIG. 4 details an intention detection system in accordance with an embodiment of the invention. Initially, several image frames from camera 310 are obtained and placed in buffer 320. Examples of cameras, include without limitation, Leopard Imaging CMOS camera, model number LI-USB30-AR023ZWDRB (Freemont, Calif.). Data from a depth sensor may also be obtained and used or fed into the intention classifier, discussed herein. Examples of depth sensors include brand RealSense Depth Camera D435i or L515, manufactured by Intel Corporation (Santa Clara, Calif.).

Body features are computed from the frames using processor 330, preferably an accelerator-type processor. In embodiments, a pretrained convolutional neural network is run on the processor and extracts the body features. Various types of neural networks may be employed as is known by those of skill in the art. An exemplary computing tool or algorithm for computing the body features from the image frames is PoseNet V2.0. See, e.g., M. Andriluka, L. Pishchulin, P. Gehler, and B. Schiele. 2d human pose estimation: New benchmark and state of the art analysis, IEEE Conference on CVPR, 2014. Body features can include, without limitation, head, torso, shoulders, arms, legs, joints, eyes, ears, nose, etc.

The computed body features are sent to memory 340, and a central processor 350 or another processer is operable to compute various characteristics relating to the individual based on the body features including, without limitation, head orientation, distance to the subject, and body motion. The body features collected from the data set will then be used to create either a statistical binary intention classifier (e.g., SVM or random forest, etc.) or a more sophisticated transfer-learning based convolutional neural network classifier to infer the intent of the detected subject. We may also infer intent from a set of conditional logic based thresholds.

In embodiments, the threshold of the classifier is dynamically based and dependent on the number of subjects seen by the camera system. For example, an access control device placed in a high traffic area (e.g., cruise ship room near an elevator) will desirably have a more stringent, tighter threshold than one at the end of a long hallway that sees little traffic. In an embodiment, an initial default threshold for a classifier model is based on expected traffic flow. Then, the threshold for each door or access control point is adjusted based on the traffic flow actually observed by the system.

In embodiments, distance to the subject is computed by calibrating the face size with distance to the camera.

In embodiments, head orientation is computed based on identifying the face, features of the face, and applying a head orientation algorithm as is known to those of skill in the art. A non-limiting example of a suitable algorithm for determining head orientation is by A. Gee and R. Cipolla, “Estimating Gaze from a Single View of a Face,” ICPR '94, 758-760, 1994.

In embodiments, body motion is computed based on tracking particular body features across multiple consecutive frames. In a preferred embodiment, the following body features are tracked across the multiple frames: shoulders, arms, nose, legs, eyes and ears.

An intention classifier 360, preferably run on a processor framework including one or more processors, determines an intention level that the individual desires to unlock/open the door based on one or more of the above mentioned computed characteristics (head orientation, distance to the subject, and body motion) and the computed body features.

In embodiments, an intention classifier is built and trained using a transfer-learning model-building tool such as, for example, Tensorflow (www.tensorflow.org) and a number of carefully designed and collected image sets. See, e.g., Abadi et al., TensorFlow: A system for large-scale machine learning, 12th USENIX Symposium on Operating Systems Design and Implementation (OSDI 16), USENIX Association (2016), pp. 265-283 and a number of carefully designed and collected image sets. In embodiments, the image sets are generated by passing a large number of subjects through a hallway having four doors. Subjects passed by some doors and opened (and entered) others. Cameras on all doors captured the event for each subject. Intension was recorded for subjects that opened and walked through the door. No intention was recorded for subjects that passed by the target door or opened other nearby doors. Using the body features from the two classes of data (Class1: subject opens door and Class2: subject does not open door), the intention classifier was specifically trained for intention with body features of subjects approaching and opening a specified door and with body features of subjects walking past a specific door. The transfer-learning based classifier provides an intention score for each image of a subject in the vicinity of a door. Once an image in the streaming sequence indicates positive intent, the intent stage is complete and the next stage is entered.

With reference to FIG. 5, an intention detection process 400 in accordance with another embodiment is illustrated. Particularly, the process 400 includes a first conditional logic layer similar to that described in connection with FIG. 4 but additionally shows a second logic layer 420 that receives prior information to facilitate computation of an intention probability 450. The prior information may include a wide range of types of information including trajectories 432 (e.g., generalized past trajectory information), environment parameters 434 (e.g., device placement and configuration, device specific prior events, time of day, time of year, etc.), and the individual characteristics 436 (subject specific information such, e.g., height, gait, etc.).

Step 452 compares a predetermined threshold to the computed intention probability. This step may be carried out on the central processor 350 described above.

Lastly, step 460 outputs whether the individual is computed to pass (namely, seeking to unlock/open the door) or not pass (namely, not seeking to unlock the door).

Face Recognition

FIG. 6 is a flow chart detailing a face matching process (800) in accordance with an embodiment of the invention.

As described above, an initial step (step 810) states to obtain one or more frames of the individual approaching the access control device. Body features 820 are also computed and stored in memory as described above in connection with FIG. 4.

Step 830 states to crop the face of the individual within the frame(s).

Step 840 employs a pretrained CNN to extract face embeddings based on the face crop and the stored body features. This step may be performed on an accelerator processor.

Step 850 submits the extracted face embeddings for matching.

Step 860 computes a similarity between the extracted face embeddings and a pre-acquired (and validated) image of the person to be identified. This step may be performed on the CPU.

A confidence level is output (step 870). Exemplary outputs for the face match state can include: high confidence match, high confidence non-match and low confidence recognition.

The face matching phase may be performed using a face matching engine including a face classifier 236 on board the device 210. Machine learning algorithms and inferencing engines 258 can also be incorporated into the device 210 or a remote server 250 for increasing the accuracy and efficiency of the above described steps, particularly, for increasing the accuracy and efficiency of face detection and matching. A communication interface 248 is shown in FIG. 3 for sending the person's image to a remote server. The server processor(s) 254, data storage 254, and memory 256 are operable to rapidly determine whether the difference between the person's image and a pre-acquired stored image is acceptable to confirm the person's identity. Examples of suitable face matching software include, without limitation, the algorithms evaluated by the NIST Face Recognition Vendor Test (FRVT).

Presentation Attack Detection

FIG. 7 illustrates a presentation attack detection (PAD) process 900 for computing whether the presented biometric information from the individual is real in accordance with an embodiment of the invention. As described herein, the PAD is particularly useful to determine whether the skin on the face is real skin.

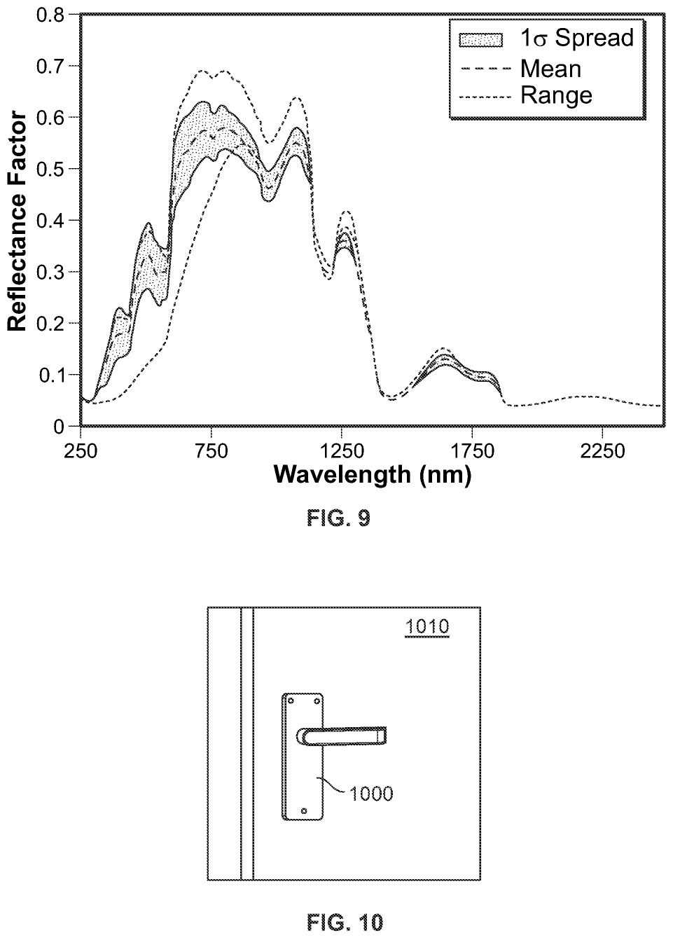

Without intending to being bound to theory, the specular reflections from skin oils combined with the morphological features of the human face provide unique image-based signatures. For example, and with reference to FIG. 9, reflectance is plotted versus wavelength for skin. The chart shows a clear and distinct dip in reflectance for the 900-1000 nm range. These signatures can be measured through simultaneous and/or non-simultaneous differential imaging formed by aligning, subtracting, and spatial filtering of images taken with different lighting/camera angles. As discussed further herein, in contrast, the reflectance signature for a mask or photo does not share these patterns and signs.

With reference again to FIG. 7, a first PAD process 900 is described. Steps 910 and 912 state to emit light towards the individual at two different wavelengths. In embodiments, the first wavelength is approximately 910 nm, and the second wavelength is approximately 970 nm. In embodiments, a first light source and second light source having a different wavelength range than the first light source is provided to direct light at the individual at different time periods, non-simultaneously. During the first period of time, the first light source is cony and the second light source is ‘off’; and during the second period of time, the second light source is cony and the first light source is ‘off’. However, it should be understood more or less light sources may be employed to carry out the invention. In another embodiment, for example, a single light source is adapted to non-simultaneously emit bursts of light having different wavelengths. An example of such a light source is very fast amplitude modulating VCSEL or LED illuminators.

Step 920 states to capture a frame for each of the two wavelengths of light. A camera sensor can capture an image frame for image processing on the computer.

Step 930 states to compute a difference image between the two images. The two images may be aligned, and one subtracted from the other to produce a difference image.

Step 940 states to crop the face in the difference image. Optionally, the face is cropped in the difference image.

Step 950 states to calculate a face signal. The computer is operable to compute a face signal level from the difference image.

Step 970 states to compare the face signal with a noise signal (step 960) corresponding to the region outside the face in the difference image. In the event the face is real, the face signal will be different from the noise signal. In the event the face is not real (e.g., a photo or mask), the face signal and noise signal will be the same. In embodiments, the signals are considered the same if the signals do not differ by more than a threshold value.

Exemplary output states from the PAD can include ‘high confidence REAL’, ‘high confidence PAD’, ‘low confidence REAL’ or ‘low confidence PAD’.

If the system determines the face is real, and the other above described assessments are passed, the access control device is unlocked or opened.

FIG. 8 illustrates another PAD system comprising a plurality of bursts of illumination 732, 734, 736, 738 directed at a face 740 of the subject. The wavelengths are chosen to uniquely distinguish between human faces and the materials that would be used for presentation attack. Exemplary wavelengths for different illuminators 910 nm and 970 nm.

The illuminator device may consist of a spatial arrangement of very fast amplitude modulating VCSEL or LED illuminators 710, 712 emitting at one or more wavelengths at calibrated positions relative to one or more sensor arrays 720 and lens 722. These sensor arrays can be of the standard imaging type, using global or rolling shutter, or by incorporating indirect time of flight measurements in with specialized sensors frequency locked with a fast amplitude modulated light source. An example of a sensor array is IMX287, manufactured by Sony Corporation. (Tokyo, Japan).

With reference again to FIG. 8, multiple bursts of light at two different wavelengths (732, 734, 736, and 738) are directed at the face 740 of the person. Reflectance and depth from indirect time of flight sensors are measured.

The information from depth, differential spectral imaging, and differential directional lighting imaging are used to form features that have a high degree of uniqueness which can be applied against a threshold value to indicate the skin is real.

For example, a normalized measurement of reflectance of a real face at 910 nm would indicate a sharp decrease or change in slope due to water absorption. In stark contrast, a measurement of reflectance of a polymer (e.g., PET) mask for the same wavelength range would show a much different slope, namely, no slope. In embodiments, the computer processor is programmed and operable to compare the two reflectance signatures and classify whether the presenting face is real based on the reflectance signature as described above.

In embodiments, depth/angle information of the face arising from the reflected light is also used to compute a more unique signature of a real face vs. a personation attack.

In embodiments, two 3D unit vectors are computed in the same coordinate system: 1) eye gaze vector and 2) face direction vector. The inner product of these two unit vectors (the cosine of the angle between the two vectors) will be constant between image frames for non-human targets approaching the camera. For live human face images, the inner product will tend to be variable between frames. Conditional logic may be used to distinguish between these two inner product signals. This feature may be used to distinguish live human targets from non-human or non-live human targets (e.g., printed face image or face image on a tablet or phone display). This inner product can be computed for each eye to accommodate subjects with artificial eyes.

In embodiments, the PAD system includes a trained deep-learning model (such as a trained CNN) to determine whether the face is real based on the above mentioned features. A suitable PAD classifier and model is built and trained using a number of custom-prepared image sets. The image sets were prepared by having subjects passing through the doors described above with their image displayed on a tablet and on a printed on paper. Two classes are defined: real face and fake face. These two classes of images are then used as input to a transfer learning based binary classifier constructed from a sophisticated pre-trained model (e.g., See Szegedy et al., Rethinking the Inception Architecture for Computer Vision, arxiv.org/pdf/1512.00567v3 [cs.CV]. The pre-trained deep convolutional base model combined with our two classes defined from the data sets above are used to generate and fine-tune our new unique PAD classifier.

High Confidence Real was recorded for real faces passing through the door. High Confidence Presentation Attack was recorded for paper and tablet-based images.

Ultimately, if the system determines the face is real, and the other above described assessments are passed, the access control device is unlocked or opened.

The access control device design may vary. FIG. 10 shows an access control device 1000 installed in a door 1010 in accordance with an embodiment of the invention. When an enrolled face for a particular door is found to be real with the intent to open the door, the computer system will send a signal, for example, over GPIO (general purpose input and output) to the control device 1000 to unlock the door so that the individual may open the door. Examples of electric door locks that may be incorporated into the handle structure include without limitation the Series 45/44 electric locks manufactured by ZKTeco USA (Fairfield, N.J.).

### Alternative Embodiments

In embodiments of the invention, enrollment, entry, or ingress of confirmed individuals may be monitored by a census or population type state of system module. The system counts the number of people unlocking/opening the door and entering the designated area; optionally maintains an image of each person entering the designated area; and maintains the person's ID, and more preferably, an anonymized ID of each person entering the designated area. The system further monitors whether a person has left the designated area such that at any time, the system tracks the total number of people in the designated area. The designated areas may be located in various types of rooms, cabins, facilities, stations, or vehicles including, without limitation, cruise ships, trains, buses, subways, arenas, airports, office buildings, and schools.

The type of door or barrier may vary widely. The invention is applicable to a wide variety of barriers including swinging or sliding type doors, as well as turnstile, baffle gate, as well as tollbooth or train crossing type bars. Additionally, in the environments where a controlled opening or ingress lacks a solid barrier, and instead controls access by an alarm or light, the access control device may be mounted adjacent the opening to obtain the images of the person and carry out the computation steps described above. If the assessment(s) are passed, the access control device sends a signal to activate the audio, alarm, or light to permit entry.

The configuration or type of access control device may vary widely. Non limiting examples of access control devices include door locks; actuators/motors for automatic sliding door(s); and electronic locks for chests, cabinets, cash registers, safes, and vaults.

Although a number of embodiments have been disclosed above, it is to be understood that other modifications and variations can be made to the disclosed embodiments without departing from the subject invention.

1. A door security system comprising:
at least one door;
an electro-mechanical device for permitting access through the at least one door;
one or more illumination sources;
at least one camera in the vicinity of the door;
a low profile unit installed in the vicinity of the electro-mechanical device, and optionally within the door, said low profile unit comprising:
a housing, and
at least one processor programmed and operable to:
acquire a sequence of images from the at least one camera of the scene in the vicinity of the device;
store the sequence of images in a memory;
compute a body motion of a subject within the scene based on the sequence of images;
determine a level of intent the subject presents to the device based on the body motion of the subject;
determine a level of confidence the subject is a match with an authorized individual based on evaluating biometric information of the subject and the authorized individual; and
activate the electro-mechanical device based on the level of intent and the level of confidence.

2. The system of claim 1, wherein the at least one processor is operable to extract orientation motion of a head, arm, or torso of the subject, and said level of intent being further based on said orientation motion of a head, arm, or torso.

3. The system of claim 2, further comprising an intention classifier trained prior to installation.

4. The system of claim 1, wherein said intention classifier is adapted to collect truth-marked, annotated and anonymized data for subsequent training.

5. The system of claim 1, wherein the at least one processor is operable to compute a level of authenticity of the subject, and prohibit activating the device based on the computed level of authenticity.

6. The system of claim 5, wherein the at least one processor is operable to compute the level of authenticity based on emitting multiple wavelengths of light towards the face of the subject, and detecting reflectance/absorption of the multiple wavelengths.

7. The system of claim 1, wherein the camera generates a sequence of images selected from the group consisting of depth images and RGB images.

8. The system of claim 1, wherein the one or more illumination sources are operable to provide visible and non-visible light.

9. The system of claim 1, wherein the at least one camera is located in the housing of the unit.

10. The system of claim 1, further comprising a communication interface adapted to communicate information with a server system.

11. A method for controlling access to an area or compartment comprising:
acquiring a sequence of images of a scene in a vicinity of an ingress to the area or compartment;
storing the sequence of images;
computing a body motion of a subject within the scene based on the sequence of images;
determining a level of intent presented by the subject based on the body motion of the subject; and
permitting access based on the level of intent.

12. The method of claim 11, further comprising the step of determining a level of confidence the subject is a match with an authorized individual based on evaluating biometric information of the subject and the authorized individual, and wherein the step of permitting is further based on the level of confidence.

13. The method of claim 12, further comprising the step of determining a level of authenticity the subject and prohibit permitting access based on the computed level of authenticity.

14. The method of claim 13, further comprising the step of computing body features using a trained neural network for determining body features.

15. The method of claim 11, further comprising the step of computing body motion, head orientation, and subject distance from the ingress based on said body features.

16. The method of claim 15, wherein the step of determining a level of intent is performed with a trained neural network for extracting an intent vector, and the level of intent is based on said body features, said computed body motion, head orientation, subject distance from the ingress, and intent vector.

17. The method of claim 15, wherein the step of determining a level of confidence is performed using a trained neural network for extracting a face vector for the subject, and the level of confidence is based on said body features and the face vector.

18. The method of claim 13, wherein the step of determining a level of authenticity is based on emitting multiple wavelengths of light towards the face of the subject, and detecting reflectance/absorption of the multiple wavelengths.

19. A non-transitory program storage device, readable by a processor and comprising instructions stored thereon to cause one or more processors to:
acquire a sequence of images of a scene in a vicinity of an access control device;
store the sequence of images in a memory;
compute a body motion of a subject within the scene based on the sequence of images;
determine a level of intent the subject presents to the access control device based on the body motion of the subject;
determine a level of confidence the subject is a match with an authorized individual based on evaluating biometric information of the subject and the authorized individual; and
activate the access control device based on the level of intent and the level of confidence.
